(19) United States
(12) Patent Application Publication
(10) Pub. No.: US 2006/0005211 A1
(43) Pub. Date: Jan. 5, 2006

(54) Electronic apparatus

(75) Inventors: Fuminori Yamazaki, Tokyo (JP); Hiroshi Nakamura, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/168,364

(22) Filed: Jun. 29, 2005

(30) Foreign Application Priority Data
Jun. 30, 2004 (JP) 2004-194574

(51) Int. Cl. G11B 17/03

(52) U.S. Cl. 720/600

(57) ABSTRACT

A portable computer includes a first housing having a slot, an optical disk drive, an ejection mechanism, and a sealing member. The optical disk drive has a tray, and a bezel disposed at the end of the tray. When the tray has moved to a first position where it lies inside the first housing, the bezel lies inside the slot and shuts the slot. The ejection mechanism moves the tray from the first position to a second position where this tray springs out of the first housing. The sealing member has a base portion which is disposed over entire periphery of the inner edge portion of the slot, and a protrusion which protrudes inward of the slot from the base portion. The sealing member seals the gap between the bezel and the slot when the tray has moved to the first position.

### CROSS-REFERENCE TO RELATED APPLICATION

This application is based upon and claims the benefit of priority from the prior Japanese Patent Application No. 2004-194574, filed on Jun. 30, 2004; the entire content of which are incorporated herein by reference.

### BACKGROUND

1. Field

Embodiments of the the invention relate to an electronic apparatus which includes a disk drive, for example, an optical disk drive.

2. Description of the Related Art

A portable computer, for example, includes a disk drive which reads the information of a disk such as an optical disk. The disk drive is often installed inside a housing in which a keyboard is disposed.

The structure of the disk drive of this type is a structure which includes a tray that detachably supports the disk. In such a disk drive, the tray comes out of the housing through a slot which is provided in, for example, the side surface of the housing of the portable computer. The tray is moved by an ejection mechanism. The disk is attached to or detached from the tray in a state where this tray lies outside the housing.

Besides, there has been a structure wherein a bezel which fits in the slot is mounted on the end of the tray. The bezel shuts the slot when the tray is accommodated inside the housing of the disk drive.

In some cases, however, dust or the like intrudes from between the slot and the bezel. When the dust intrudes into the interior of the disk drive, such a problem occurs that the portable computer becomes inoperable.

Therefore, a structure wherein the bezel is surrounded with a sealing member for dust prevention has been proposed as a dustproof countermeasure (refer to, for example, JP-A-10-162565).

### BRIEF DESCRIPTION OF THE DRAWINGS

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is an exemplary perspective view of a portable computer according to one embodiment of the present invention.

FIG. 2 is an exemplary sectional view taken along line F2-F2 which is indicated in FIG. 1.

FIG. 3 is an exemplary sectional view taken along line F3-F3 which is indicated in FIG. 1.

FIG. 4 is an exemplary sectional view showing a state where a tray shown in FIG. 3 has been moved.

FIG. 5 is an exemplary sectional view showing a state where an optical disk drive has been demounted from the portable computer shown in FIG. 1.

FIG. 6 is an exemplary perspective view showing a state where the optical disk drive has been demounted from the portable computer shown in FIG. 1, and where the left sidewall of the first housing of the portable computer has been partially broken away.

FIG. 7 is an exemplary sectional view taken along line F7-F7 which is indicated in FIG. 1.

FIG. 8 is an exemplary sectional view showing a state where the tray shown in FIG. 7 has been pushed out to a detachment position.

### DETAILED DESCRIPTION

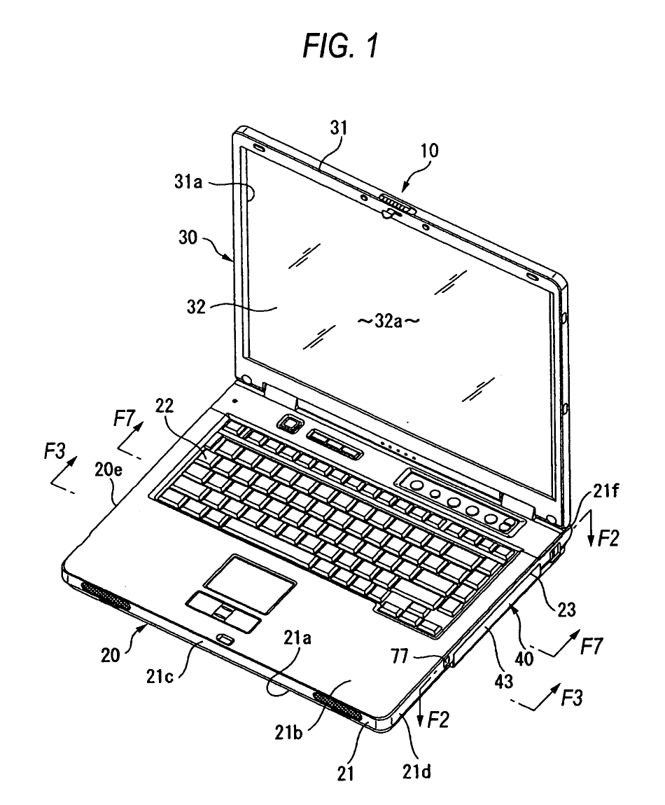

An electronic apparatus according to one embodiment of the present invention will be described with reference to FIGS. 1 through 8 by taking a portable computer 10 as an example.

As shown in FIG. 1, the portable computer 10 includes a computer body 20 and a display unit 30. The computer body 20 has a first housing 21. The first housing 21 is an example of a “housing” in the embodiment of the invention. This first housing 21 is in the shape of a flat box. It has a bottom wall 21a, a top wall 21b, a front wall 21c, a left sidewall 21d, a right sidewall 21e and a rear wall 21f.

The display unit 30 includes a second housing 31 and a liquid-crystal display panel 32. The liquid-crystal display panel 32 is accommodated in the second housing 31. This liquid-crystal display panel 32 has a screen 32a for displaying an image. The screen 32a is exposed outside the second housing 31 through an opening portion 31a which is formed in the front surface of this second housing.

The second housing 31 is supported at the rear end part of the first housing 21 through a hinge not shown. The display unit 30 is turnable between a shut state and an open state. The shut state is a state where the display unit 30 lies on the computer body 20 so as to cover a keyboard 22 from above. The open state is a state where the display unit 30 erects itself relative to the computer body 20 so as to expose the keyboard 22 and the screen 32a.

The computer body 20 includes an optical disk drive 40, an ejection mechanism 80, a sealing member 50, a lock mechanism 60 and an auxiliary ejection mechanism 70.

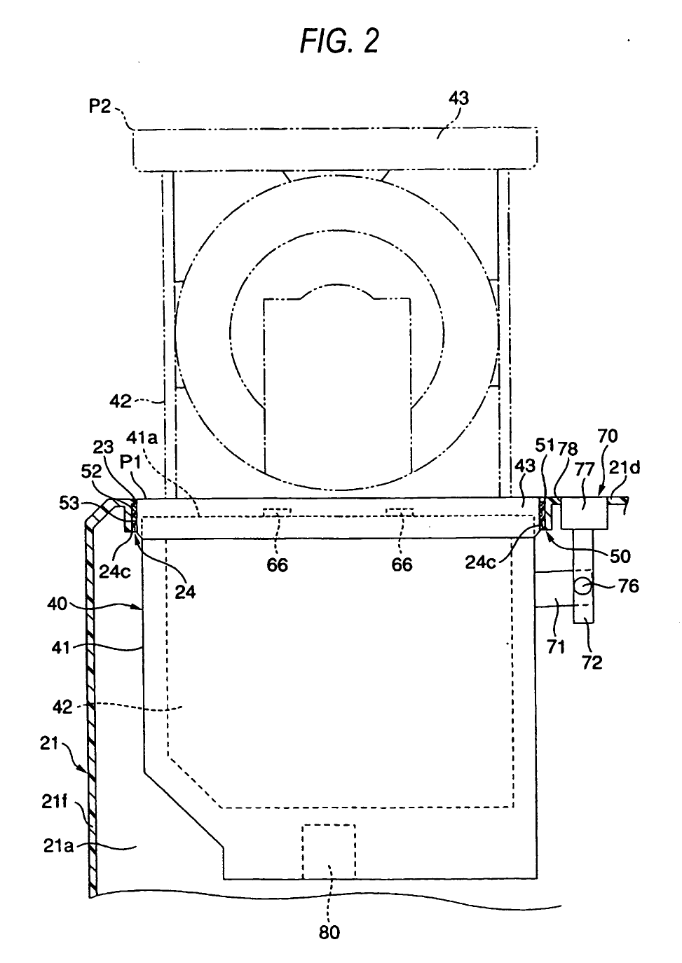

The optical disk drive 40 is an example of a “disk drive” termed in the embodiment of the invention. As shown in FIG. 2, the optical disk drive 40 is accommodated inside the first housing 21. The optical disk drive 40 includes the drive proper 41, a tray 42 and a bezel 43.

The drive proper 41 has the functions of reading the information of an optical disk, writing information into the optical disk, etc. An opening 41a is formed in one side surface of the drive proper 41. The drive proper 41 accommodates the tray 42 so as to be capable of bringing it in and out through the opening 41a.

The drive proper 41 is fixed in the first housing 21 so that the opening 41a may oppose to the left sidewall 21d of this first housing 21. The left sidewall 21d is provided with a slot 23 at a position at which it opposes to the opening 41a of the drive proper 41. The slot 23 has a size which is large enough to pass the tray 42 therethrough. Therefore, the tray 42 can come from a first position P1 to the exterior of the first housing 21 through the slot 23. The first position P1 is a position at which the tray 42 lies inside the drive proper 41.

The bezel 43 is provided at the end of the tray 42. This bezel 43 is in the shape of fitting in the slot 23. It shuts the slot 23 when the tray 42 lies at the first position P1. Incidentally, a groove not shown is formed in that side surface of the bezel 43 which faces the drive proper 41, and one end part of the drive proper 41 is accommodated in the groove of the bezel 43 when the tray 42 lies at the first position P1.

The ejection mechanism 80 is accommodated in the drive proper 41 by way of example. This ejection mechanism 80 is an example of a “first ejection mechanism” termed in the embodiment of the invention. It moves the tray 42 between the first position P1 and a second position P2. As indicated by two-dot chain lines in FIG. 2, in this embodiment, the second position P2 is a position at which the optical disk is attachable to the tray 42. Or, it is a position at which the optical disk is detachable. The ejection mechanism 80 is driven by a drive switch not shown.

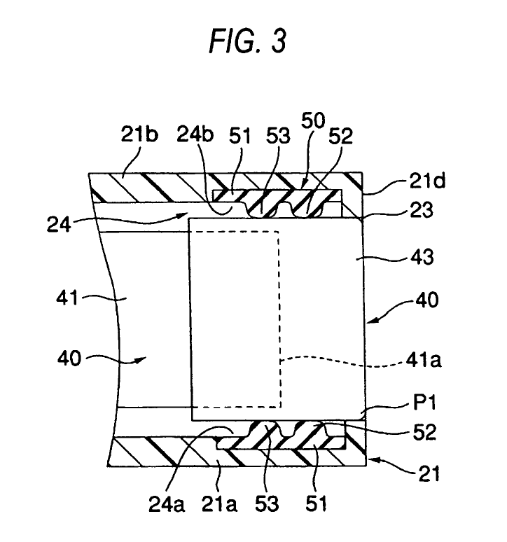

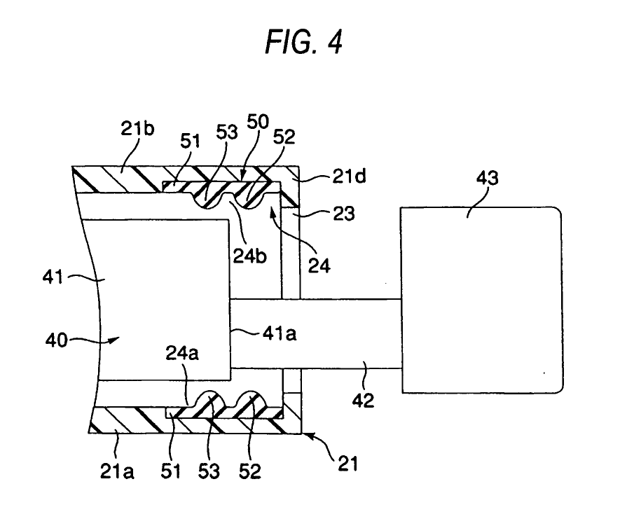

The sealing member 50 is annular, and it is provided over an entire periphery of the inner edge portion 24 of the slot 23. The inner edge portion 24 is constructed of a bottom edge 24a, a top edge 24b and both side edges 24c. As shown in FIGS. 3 and 4, the bottom edge 24a is provided at part of the bottom wall 21a of the first housing 21. The top edge 24b is provided at part of the top wall 21b of the first housing 21.

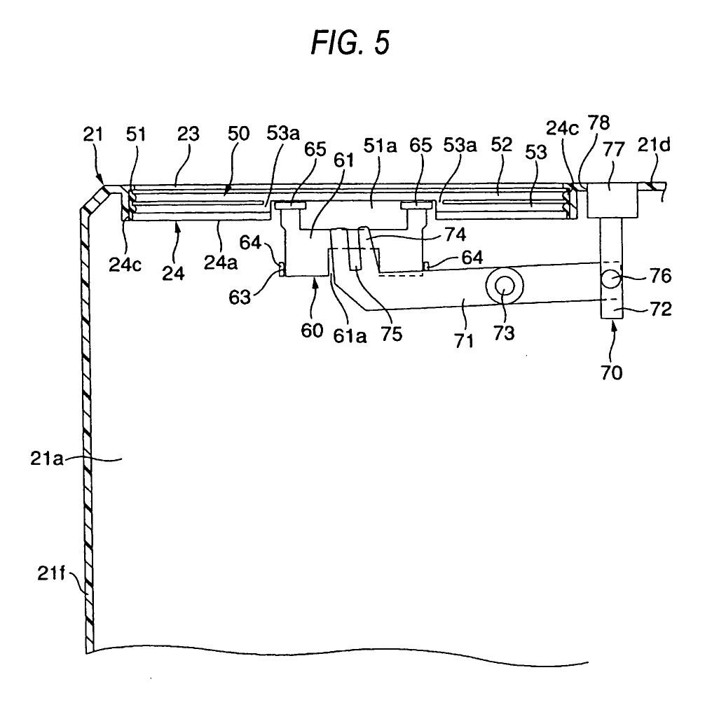

As shown in FIGS. 2 and 5, the side edges 24c are respectively formed in such a way that parts of the left sidewall 21d of the first housing 21 are protruded inward of this first housing 21. These side edges 24c extend entirely between the bottom edge 24a and the top edge 24b. Therefore, the inner edge portion 24 is in the shape of a continuous enclosure which covers the slot 23.

Incidentally, the inner edge portion 24 is not restricted to the above structure. Essentially, the inner edge portion 24 may be provided with the annular sealing member 50.

As shown in FIG. 5, the sealing member 50 has a base portion 51, a protrusion 52 and an auxiliary protrusion 53. Incidentally, FIG. 5 shows a state where the optical disk drive 40 has been removed from FIG. 2.

The base portion 51 is provided over the whole periphery of the inner edge portion 24 of the slot 23, and it is fixed. In the base portion 51, substantially the central part of its position corresponding to the bottom edge 24a has a first recess 51a which is concave avoiding the locking member 61 of the lock mechanism 60 to be stated later.

The protrusion 52 is formed unitarily with the base portion 51. This protrusion 52 is convex inward of the slot 23 from the whole periphery of the base portion 51 except the first recess 51a. As shown in FIG. 4, the protrusion 52 is substantially in the shape of a circular arc. As shown in FIG. 3, the protrusion 52 is somewhat crushed between the bezel 43 and the inner edge portion 24 when the tray 42 lies at the first position P1, but it lies substantially in point contact with the bezel 43. More specifically, the protrusion 52 lies in close contact with the peripheral surface of the bezel 43 over the whole periphery thereof with an area which is smaller than that of the base portion 51.

Besides, in a case where a relative dimensional tolerance is involved between the slot 23 and the bezel 43, the protrusion 52 absorbs the dimensional tolerance by being deformed. Thus, the protrusion 52 liquid-tightly shuts the gap between the inner edge portion 24 of the slot 23 and the bezel 43 when the tray 42 lies at the first position P1.

The auxiliary protrusion 53 is formed unitarily with the base portion 51. As shown in FIG. 5, the auxiliary protrusion 53 is arranged on the inner side of the first housing 21 in the moving direction of the tray 42 relatively to the protrusion 52, and it is convex inward of the slot 23. This auxiliary protrusion 53 is broken off by the first recess 51a, but it is formed in continuation at the top edge 24b, both the side edges 24c and the bottom edge 24a except the first recess 51a.

As shown in FIG. 4, the auxiliary protrusion 53 is substantially in the shape of a circular arc. As shown in FIG. 3, the auxiliary protrusion 53 is somewhat crushed between the bezel 43 and the inner edge portion 24 when the tray 42 lies at the first position P1, but it lies substantially in point contact with the peripheral surface of the bezel 43. More specifically, the auxiliary protrusion 53 lies in close contact with the peripheral surface of the bezel 43 with an area which is smaller than that of the base portion 51. Besides, in a case where a relative dimensional tolerance is involved between the slot 23 and the bezel 43, the auxiliary protrusion 53 absorbs the dimensional tolerance by being deformed.

Besides, as shown in FIG. 5, both the end parts 53a of the auxiliary protrusion 53 facing the first recess 51a are unitarily connected with the protrusion 52, respectively. Therefore, the auxiliary protrusion 53 liquid-tightly shuts the gap between the inner edge portion 24 of the slot 23 and the bezel 43 when the tray 42 lies at the first position P1.

That is, the sealing member 50 liquid-tightly seals the gap between the inner edge portion 24 of the slot 23 and the bezel 43 when the tray 42 lies at the first position P1. Incidentally, although the single protrusion 52 is formed in this embodiment, the invention is not restricted thereto. A plurality of protrusions 52 may well be formed. Likewise, a plurality of auxiliary protrusions 53 may well be formed.

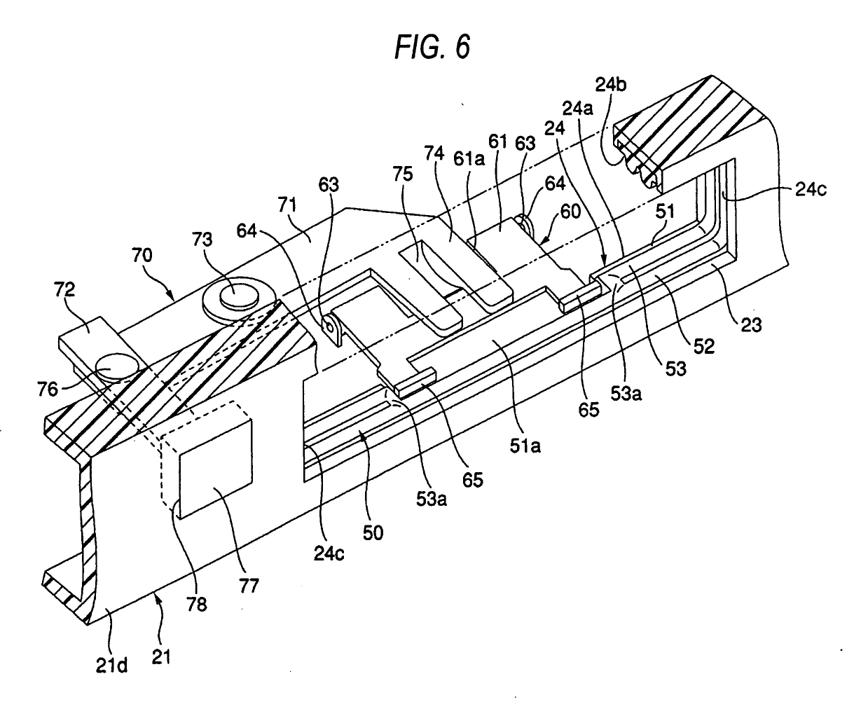

The lock mechanism 60 includes the locking member 61, and a spring 62 which is means for urging the locking member 61. As shown in FIGS. 5 and 6, the locking member 61 is arranged along the left sidewall 21d of the first housing 21. In the locking member 61, end parts remote from the left sidewall 21d are respectively mounted on support portions 64 provided on the bottom wall 21a of the first housing 21, through first arbors 63 so that this locking member may be turnable in the direction of coming away from the bottom wall 21a.

Since the locking member 61 is disposed to be lower than the tray 42 and the bezel 43, it does not interfere with the movement of the tray 42.

The end part of the locking member 61 near to the left sidewall 21d is bifurcated, and it extends into the first recess 51a of the base portion 51 of the sealing member 50. The bifurcate end parts of the locking member 61 near to the left sidewall 21d are respectively provided with engagement lugs 65.

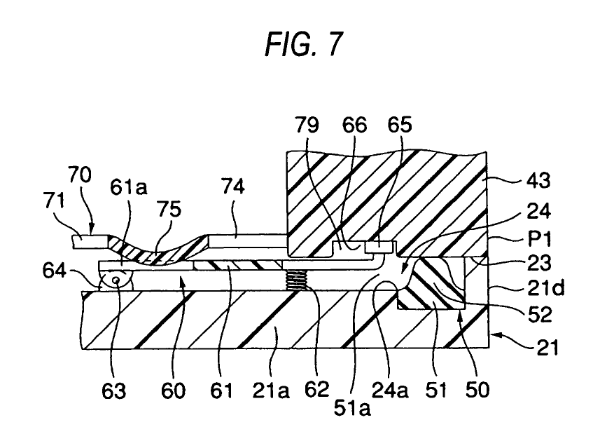

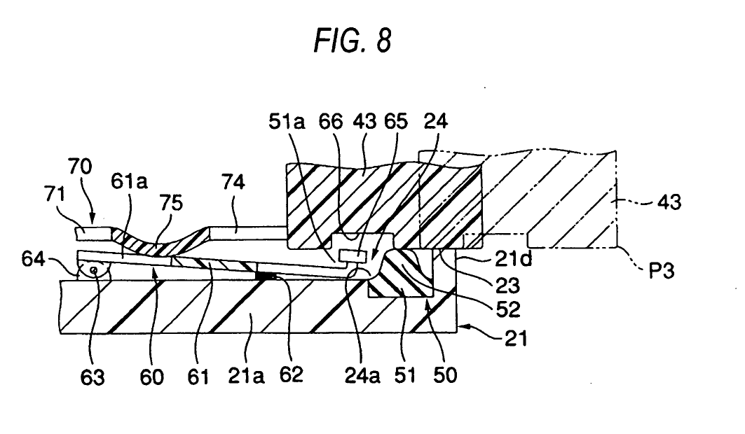

As shown in FIGS. 7 and 8, the engagement lugs 65 protrude upwards. The bezel 43 is formed with engagement dents 66 at its positions which correspond to the engagement lugs 65 when the tray 42 lies at the first position P1. Each of the engagement dents 66 has a size which is large enough to accommodate the corresponding engagement lug 65 therein. Besides, as shown in FIG. 5, the locking member 61 is partially cut away at the central part of its end part remote from the engagement lugs 65, whereby a second recess 61a is formed.

As shown in FIGS. 7 and 8, the spring 62 is retained between the locking member 61 and the bottom wall 21a of the first housing 21. The spring 62 urges the locking member 61 upwards. Therefore, when the tray 42 lies at the first position P1, the engagement lugs 65 are respectively accommodated in the engagement dents 66. Thus, the engagement lugs 65 and the corresponding engagement dents 66 are respectively held in engagement. The lock mechanism 60 locks the tray 42 at the first position P1.

The auxiliary ejection mechanism 70 is an example of a “second ejection mechanism” termed in the embodiment of the invention. As shown in FIGS. 5 and 6, the auxiliary ejection mechanism 70 includes a first linking member 71 and a second linking member 72. The first linking member 71 is in the shape of a plate which extends unidirectionally. This first linking member 71 is arranged along the left sidewall 21d of the first housing 21. The central part of the first linking member 71 is supported on the first housing 21 through a second arbor 73 so that this first linking member may be turnable substantially along the bottom wall 21a.

One end part of the first linking member 71 extends to the second recess 61a of the locking member 61, and it is bent to extend toward the bezel 43, whereby a pushout portion 74 is formed. The pushout portion 74 is bifurcated. As shown in FIG. 7, the pushout portion 74 lies above the locking member 61, and opposes to the lower end of the bezel 43. This pushout portion 74 pushes the bezel 43 out of the slot 23 in such a way that the locking member 61 turns round the second arbor 73.

Besides, an unlocking bulge 75 is formed at the root part of the pushout portion 74. The unlocking bulge 75 protrudes toward the bottom wall 21a of the first housing 21. When the tray 42 lies at the first position P1, the unlocking bulge 75 is accommodated inside the second recess 61a of the locking member 61.

As shown in FIG. 8, in a case where the pushout portion 74 pushes out the bezel 43, the unlocking bulge 75 comes out of the second recess 61a and comes into contact with the locking member 61 as the pushout portion 74 moves. Thus, the locking member 61 is pushed downwards. The unlocking bulge 75 pushes the locking member 61 downwards until the engagement lugs 65 are disengaged from the corresponding engagement dents 66 with the movement of the pushout portion 74.

Besides, the unlocking bulge 75 has a predetermined length in the moving direction of the pushout portion 74 in order to continue pushing the locking member 61 downwards until the engagement dents 66 come away from their positions above the engagement lugs 65 after the release of the engaged state between the engagement lugs 65 and the corresponding engagement dents 66.

As shown in FIGS. 5 and 6, the second linking member 72 is in the shape of a plate which extends unidirectionally. One end part of the second linking member 72 is connected with the end part of the first linking member 71 as is remote from the pushout portion 74 with respect to the second arbor 73, so that the first linking member 71 may be turnable substantially along the bottom wall 21a through a third arbor 76. The other end part of the second linking member 72 forms a depression portion 77. The depression portion 77 is accommodated in a depression hole 78 which is formed in the left sidewall 21d of the first housing 21. The depression hole 78 penetrates through the left sidewall 21d.

When the depression portion 77 is depressed, the second linking member 72 moves inward of the first housing 21. When the second linking member 72 moves inward of the first housing 21, the first linking member 71 turns round the second arbor 73.

As indicated by a two-dot chain line in FIG. 8, owing to the above structure, the auxiliary ejection mechanism 70 pushes out the tray 42 from the first position P1 toward the second position P2 up to a detachment position P3 at which the bezel 43 leaves the sealing member 50. Therefore, the unlocking bulge 75 has a size which permits this unlocking bulge to come out of the second recess 61a of the locking member 61 and to strand onto the locking member 61.

Besides, after having pushed out the tray 42 to the detachment position P3 where the bezel 43 leaves the sealing member 50, the first linking member 71 has its attitude held. Thus, the locking member 61 is held in the state where this locking member has been turned round the first arbors 63 by the unlocking bulge 75 up to its position at which the engagement lugs 65 are out of engagement with the respectively corresponding engagement dents 66.

Besides, when the tray 42 is returned to the first position P1, the bezel 43 pushes the pushout portion 74, whereby the first linking member 71 is turned round the second arbor 73 in the reverse direction to the direction in which the pushout portion 74 pushes out the bezel 43. Therefore, when the tray 42 lies at the first position P1, the end parts of the pushout portion 74 are in a state where they lie substantially in contact with the bezel 43.

Further, as shown in FIG. 7, each of the engaging dents 66 has such a size that, when the tray 42 lies at the first position P1, a movement margin 79 is defined between the corresponding engagement lug 65 and the side end of the engagement dent 66 near to the first linking member 71. The movement margin 79 serves to make the tray 42 movable since the pushout portion 74 begins to push out the bezel 43, until the engaged state between the engagement lugs 65 and the corresponding engagement dents 66 is completely released.

Next, the operation of the portable computer 10 will be described by exemplifying a case where the optical disk is attached onto the tray 42.

As shown in FIGS. 3 and 7, when the tray 42 lies at the first position P1, the bezel 43 is accommodated inside the inner edge portion 24 of the slot 23. The protrusion 52 and the auxiliary protrusion 53 lie in close contact with the peripheral surface of the bezel 43, and they liquid-tightly shuts the gap between the inner edge portion 24 of the slot 23 and the peripheral surface of the bezel 43. Even when, in this state, a liquid such as water has splashed on the left sidewall 21d of the first housing 21, it does not penetrate into the computer body 20 from between the inner edge portion 24 of the slot 23 and the peripheral surface of the bezel 43.

Subsequently, when the user of the portable computer 10 has prepared the optical disk which is to be attached to the optical disk drive 40, he/she pushes the drive switch which drives the ejection mechanism 80. When the drive switch is pushed, the ejection mechanism 80 tries to push the tray 42 out of the drive proper 41.

Subsequently, the user depresses the depression portion 77 of the auxiliary ejection mechanism 70 inward of the first housing 21. When the depression portion 77 is depressed, the second linking member 72 is moved inward of the first housing 21. When the second linking member 72 is moved inward of the first housing 21, one end part of the first linking member 71 turnably connected by the third arbor 76 is moved into the first housing 21 together with the second linking member 72.

Thus, the first linking member 71 turns round the second arbor 73, and the pushout portion 74 begins to push out the bezel 43. When the pushout portion 74 has pushed out the bezel 43 a predetermined distance, the unlocking bulge 75 abuts on the locking member 61 and begins to push the locking member 61 downwards.

As shown in FIG. 8, when the pushout portion 74 has pushed out the bezel 43 still further, the locking member 61 turns round the first arbors 63 until the engaged state between the engagement lugs 65 and the corresponding engagement dents 66 is released by the unlocking bulge 75. When the depression portion 77 has been further pushed in, the pushout portion 74 pushes out the bezel 43 still further. As indicated by the two-dot chain line in FIG. 8, when the tray 42 has been pushed out to the detachment position P3 where the close contact state between the sealing member 50 and the bezel 43 is released, a sliding resistance relative to the sealing member 50 stops acting on the bezel 43.

Owing to the push of the drive switch, the ejection mechanism 80 continues its drive so as to push out the tray 42 while this tray 42 moves from the first position P1 to the detachment position P3. As shown in FIG. 2, therefore, when the tray 42 has led to the detachment position P3, it is pushed out to the second position P2 by the ejection mechanism 80.

When the tray 42 has led to the second position P2, the optical disk is attached onto the tray 42. When the optical disk has been attached onto the tray 42, the user of the portable computer 10 pushes the drive switch of the ejection mechanism 80. When the drive switch has been pushed, the ejection mechanism 80 pulls back the tray 42 into the drive proper 41. On this occasion, when the tray 42 has been pulled back to the position where the bezel 43 lies in contact with the sealing member 50, that is, the detachment position P3, the user pushes the bezel 43 inwards. Owing to the inward push of the bezel 43, the tray 42 returns to the first position P1 again.

In this manner, the sealing member 50 of the portable computer 10 has the structure in which the protrusion 52 protrudes from the whole periphery of the base portion 51 that is fixed to the whole periphery of the inner edge portion 24 of the slot 23, and in which this protrusion 52 lies in close contact with the peripheral surface of the bezel 43 over the whole periphery thereof. Therefore, the liquid such as water can be prevented from intruding from between the inner edge portion 24 of the slot 23 and the peripheral surface of the bezel 43. That is, the water-proofness of the portable computer 10 is enhanced.

Besides, the protrusion 52 lies in close contact with the peripheral surface of the bezel 43 with an area which is smaller than that of the base portion 51. Therefore, the sliding resistance between the sealing member 50 and the peripheral surface of the bezel 43 can be lowered. That is, notwithstanding that the close adhesion between the sealing member 50 and the peripheral surface of the bezel 43 is enhanced in order to liquid-tightly shut the gap between the inner edge portion 24 of the slot 23 and the peripheral surface of the bezel 43, the sliding resistance between the sealing member 50 and the peripheral surface of the bezel 43 can be suppressed.

Further, the protrusion 52 undergoes deformation such as crush, thereby to absorb the relative dimensional tolerance between the inner edge portion 24 of the slot 23 and the bezel 43, so that the water-proofness of the portable computer 10 can be enhanced.

Still further, the protrusion 52 protrudes in the shape of the circular arc, and hence, it can decrease its area of the close contact with the peripheral surface of the bezel 43. Therefore, the sliding resistance between the sealing member 50 and the peripheral surface of the bezel 43 can be suppressed.

Besides, the sealing member 50 includes the auxiliary protrusion 53. Thus, the water-proofness of the portable computer 10 is enhanced. Both the end parts 53a of the auxiliary protrusion 53 are respectively connected to the protrusion 52. Thus, the auxiliary protrusion 53 liquid-tightly shuts the gap between the inner edge portion 24 of the slot 23 and the peripheral surface of the bezel 43, so that the water-proofness of the portable computer 10 is enhanced.

Further, the auxiliary protrusion 53 undergoes deformation such as crush, thereby to absorb the relative dimensional tolerance between the inner edge portion 24 of the slot 23 and the bezel 43, so that the water-proofness of the portable computer 10 can be enhanced.

Still further, the auxiliary protrusion 53 protrudes in the shape of the circular arc, and hence, it can decrease its area of the close contact with the peripheral surface of the bezel 43. Therefore, the sliding resistance between the sealing member 50 and the peripheral surface of the bezel 43 can be suppressed.

Besides, the portable computer 10 includes the lock mechanism 60. Thus, the tray 42 is restrained from unintentionally springing out of the computer body 20.

Besides, the portable computer 10 includes the auxiliary ejection mechanism 70. The auxiliary ejection mechanism 70 pushes out the tray 42 to the detachment position P3 at which the bezel 43 leaves the sealing member 50. Thus, notwithstanding that the force of the close contact between the sealing member 50 and the peripheral surface of the bezel 43 has been intensified in order to heighten the liquid-tightness between the sealing member 50 and the peripheral surface of the bezel 43, the tray 42 can be moved to the second position P2. That is, the portable computer 10 has its water-proofness enhanced with its operability considered.

Besides, the auxiliary ejection mechanism 70 serves also as an unlocking mechanism which releases the locked state of the lock mechanism 60. That is, since the unlocking mechanism is constructed by utilizing the structure of the auxiliary ejection mechanism 70, it is not constructed separately. Thus, the portable computer 10 has the number of components diminished.

In this embodiment, the second position P2 is set at the position at which the tray 42 can replace the disk, but it is not restrictive. In a case, for example, where the ejection mechanism 80 has a structure which somewhat protrudes the tray 42 from the drive proper 41, and where the tray 42 is moved by the user of the portable computer 10, the second position P2 is a position to which the tray 42 is projected by the ejection mechanism 80.

Besides, the sealing member 50 is fixed to the inner edge portion 24 of the slot 23, but this is not restrictive. By way of example, the sealing member 50 may be fixed to the peripheral surface of the bezel 43. Alternatively, the sealing member 50 may well be provided on both the inner edge portion 24 of the slot 23 and the peripheral surface of the bezel 43.

What is claimed is:

1. An electronic apparatus comprising:
a housing having a slot;
a disk drive having:
a tray detachably supporting a disk; and
a bezel disposed at an end of the tray, the tray being movable between a first position where the tray is in the housing and a second position where the tray is ejected through the slot, and the bezel being disposed inside the slot and shuts the slot when the tray is moved to the first position;
an ejection mechanism moving the tray from the first position to the second position; and
a sealing member provided at the housing, and the sealing member sealing a gap between the bezel and the slot when the tray is moved to the first position, the sealing member having;
a base portion being along an entire periphery of an inner edge portion of the slot; and
a protrusion protruding inward of the slot from the base portion.

2. An electronic apparatus according to claim 1, wherein the sealing member includes an auxiliary protrusion, and
wherein the auxiliary protrusion protrudes inward of the slot from the base portion, and
wherein the auxiliary protrusion at least partially contacts with a peripheral surface of the bezel.

3. An electronic apparatus according to claim 2, wherein the protrusion and the auxiliary protrusion are juxtaposed with a gap in a moving direction of the tray.

4. An electronic apparatus according to claim 3, further comprising:
a lock mechanism locking the tray at the first position.

5. An electronic apparatus according to claim 4, further comprising:
an auxiliary ejection mechanism moving the tray from the first position toward the second position up to a position where the bezel leaves the sealing member.

6. An electronic apparatus according to claim 5, wherein the auxiliary ejection mechanism includes an unlocking mechanism which releases the lock of the tray based on the lock mechanism.

7. An electronic apparatus comprising:
a housing having a slot;
a disk drive having:
a tray detachably supporting a disk; and
a bezel disposed at an end of the tray, the tray being movable between a first position where the tray lies inside the housing and a second position where the tray springs out of the housing through the slot, and the bezel being disposed inside the slot and shuts the slot when the tray is moved to the first position;
a sealing member sealing a gap between the bezel and the slot when the tray is moved to the first position;
a first ejection mechanism ejecting the tray from the first position; and
a second ejection mechanism moving the tray toward the second position so as to leave the bezel from the sealing member.

8. An electronic apparatus according to claim 7, further comprising:
a lock mechanism locking the bezel at the first position.

9. An electronic apparatus according to claim 8, wherein the second ejection mechanism includes an unlocking mechanism which releases the lock of the tray based on the lock mechanism.
